(19) United States
(12) Patent Application Publication
(10) Pub. No.: US 2017/0228783 A1
(43) Pub. Date: Aug. 10, 2017

(54) SYSTEM AND METHOD FOR PRODUCING LOCATION-SPECIFIC MARKETING MATERIALS FOR A MULTI-OUTLET ENTERPRISE

(71) Applicant: Telephone and Data Systems, Inc., Chicago, IL (US)

(72) Inventors: Christopher Daniel Theisen, Madison, WI (US); James Matthew Twieg, Waunakee, WI (US)

(21) Appl. No.: 15/040,883

(22) Filed: Feb. 10, 2016

(51) Int. Cl. G06Q 30/02

(52) U.S. Cl. CPC G06Q 30/0259; G06Q 30/0276

(57) ABSTRACT

A system is described for producing location-specific print media for a multi-outlet enterprise. The system includes a marketing media builder configured to provide a set of print media design templates for the multi-outlet enterprise, wherein the templates include variable data fields. The system further includes a location manager comprising a database configured to maintain sets of location-specific information for populating the variable data fields of the set of print media design templates. A print quality image file is generated by the marketing media builder by populating the variable form fields with variable data acquired from the location manager for a particular location.

### FIELD OF THE INVENTION

This invention relates generally to the field of automated marketing materials generation, and more particularly the invention relates to integrated systems for managing design and dissemination of marketing materials for multi-outlet business enterprises.

### BACKGROUND OF THE INVENTION

Places of business, such as restaurants, stores, and service providers, rely upon a variety of print media for advertisement and promotion of their goods and services. Examples of such print media include posters, coupons, menus, business cards, flyers, etc. Design and production of such materials have, in recent years, been aided by a variety of electronic publishing and production control and management systems. Desktop media publishing tools enable users to generate company branded print media and reusable templates that streamline designing new print media materials. Once designed and stored in print-ready file formats, new print media designs are thereafter rendered on a variety of potential output forms via integrated print media production systems.

The highly integrated print media design and production systems facilitate generating a wide variety and vast quantity of print media output in a relatively short time span. As such, the aforementioned integrated print media design and production systems are highly desirable to enterprises made up of tens, hundreds and even thousands of outlets (e.g. franchises, retail locations, branches), in multi-outlet enterprises, each individual outlet may have a need to customize particular elements within print media for marketing (flyers, posters, etc.) and/or operations (e.g., menus). The integrated print media design and production systems may be used in a multi-outlet environment to provide location-specific print media where location-specific print media is rendered from print media templates.

Across a multi-outlet enterprise, individual outlets may need location-specific print media designs to accommodate unique characteristics of the particular location. The print media templates are characterized by static (i.e. non-changing) design elements that are unchanged throughout the enterprise. Examples of a static element are company logos. The print media templates are further characterized by variable (i.e. changeable) design elements that may be supplied/modified to provide customized outlet/location-specific print media including location-specific modifications to certain types of design elements.

### SUMMARY OF THE INVENTION

The exemplary systems and methods described herein are directed to producing location-specific print media for a multi-outlet enterprise. The system includes a marketing media builder configured to provide a set of print media design templates for the multi-outlet enterprise, wherein the templates include variable data fields. The system further includes a location manager comprising a database configured to maintain sets of location-specific information for populating the variable data fields of the set of print media design templates. The system also includes a physical print media printer configured to render print media output in physically tangible form.

Additionally, the system includes a print-on-demand order management system comprising a processor and a non-transitory computer-readable medium including computer executable instructions that, when executed by the processor, facilitate performing on the print-on-demand order management system, the steps of: receiving a request for generating a print job specifying a print quality image file from the marketing media builder, receiving a request for a particular output form for printing a physical rendering of the print quality image file, and issuing instructions and data to the physical print media printer to render physical print media output according to the print quality image file and the particular output form. The print quality image file is generated by the marketing media builder by populating the variable form fields with variable data acquired from the location manager for a particular location.

The claimed invention is further directed to a method carried out by the above-described system as well as computer readable media (non-transitory) containing computer-executable instructions that, when executed by a processor, facilitate performing the claimed method.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram illustrating an integrated marketing materials design and dissemination system;

FIG. 2A is a schematic diagram identifying components of a location manager functional component of the integrated marketing materials design and dissemination system depicted in FIG. 1;

FIG. 2B is a listing of exemplary types of tables containing information relating to managing location-specific marketing materials customization information maintained within client-specific databases;

FIG. 3A is a flowchart summarizing a page load operation for a web page of a marketing resource center incorporating a location manager functional component of FIG. 2;

FIG. 3B is an exemplary output display for the location manager upon completion of the operations summarized in FIG. 3A;

FIG. 4 is a flowchart summarizing an approval operation carried out by the location manager component for processing a submitted change to an existing outlet location of an enterprise through a marketing resource center user interface incorporating the location manager component of FIG. 2 facilitating managing outlet/location-specific values for variable elements of defined print media designs for a multi-outlet enterprise;

FIG. 5 is an exemplary user interface for a user selecting a particular outlet location for editing information associated with the particular selected location;

FIG. 6 is an exemplary tool bar interface exposing a set of business logic functions supported by the location manager of FIG. 2;

FIG. 7 is an exemplary user interface for editing the information associated with a designated location for an outlet associated with a multi-outlet enterprise; and

FIG. 8 is an exemplary user interface used by an identified approver in an approval list, allowing the approver to approve or reject a proposed change to a particular location manager form field.

### DETAILED DESCRIPTION OF THE DRAWINGS

The figures and associated written description provide illustrative examples of a system and method for supporting and carrying out customized design and dissemination of print media materials for marketing and/or operations of particular outlets/locations in a multi-outlet enterprise.

Embodiments of the invention are used to provide a system and method for managing design and dissemination of location-specific marketing materials for multi-outlet enterprises. The system leverages Internet interfaces for providing access to centralized marketing material development tools and previously generated marketing material definitions. The system includes a user interface including a user-selectable enumeration of consumer outlets, generalized templates for the enterprise, and customization tools to produce location-specific marketing materials for particular ones of the enumerated outlets for the enterprise. The generalized templates facilitate unified branding across the multiple consumer outlets. The customization tools facilitate streamlining outlet-specific versions of each generalized template to support location-specific marketing on an outlet-by-outlet basis.

Thus, in the case of franchise-based businesses, templates including static and variable print media design elements, as well as approval-enforced limitations on certain variable design elements, facilitate corporate enterprise controls with regard to overall branding and policy enforcement with regard to print media generated for particular outlets/locations. In illustrative embodiments, a location manager ensures enforcement of overall corporate design requirements while meeting individual franchises' location-specific print media design needs. Additionally, the location manager facilitates design and dissemination of media (both on-line and print) relating to local advertisement campaigns.

Features of exemplary embodiments include: a scalable, enterprise class e-commerce framework; managed user roles, including the ability to set role-specific permissions for marketing material design and approval; close integration between distinct functional components via standardized interfaces; wide support of various marketing streams including e-mail; well-defined control over individual customization via templates; user friendly editing tool interfaces; Real-time list acquisition & segmentation; managed location data and integrated databases; and Automated workflows for print-on-demand, fulfillment & distribution.

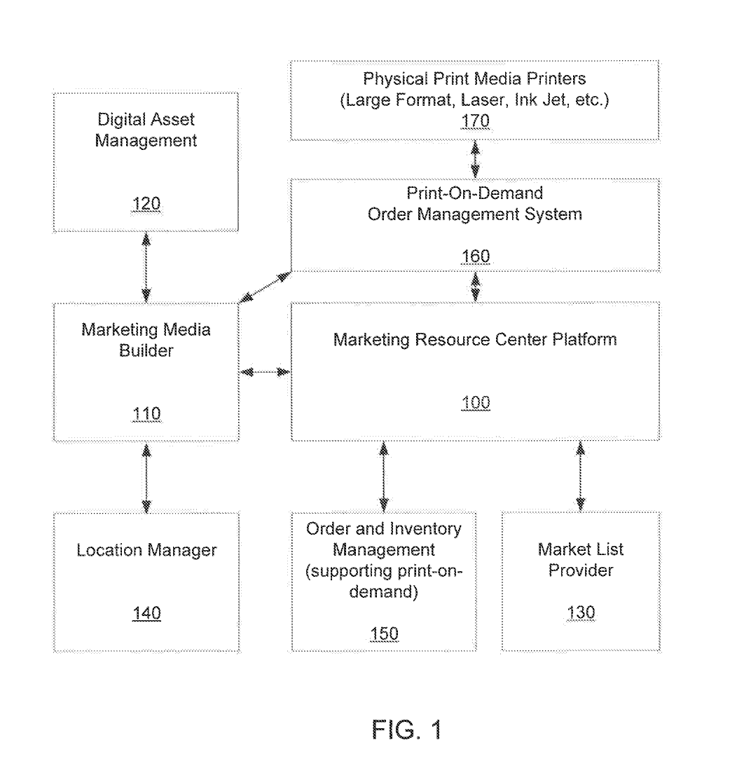

Turning to FIG. 1, a schematic diagram depicts functional components of an exemplary system for designing and disseminating marketing materials in a variety of forms using an integrated set of design and production tools. The illustrative system is implemented, by way of example, in a networked environment comprising a variety of programmed computer hardware configured with non-transitory computer readable media including computer executable instructions for carrying out the processes and procedures described herein. However, a variety of implementations are contemplated in various networked arrangements for carrying out the described functionality of the system.

In the illustrative embodiment a marketing resource center 100 provides location-specific marketing material customization support services to businesses based upon generalized branded templates for a multi-outlet enterprise (e.g. a franchise-based corporation). The marketing resource center 100 includes a web-based user interface component through which marketing material resource providers facilitate interaction with marketing material design and dissemination clients, including corporate clients having multiple affiliated outlet locations requiring location-specific marketing material designs. The marketing resource center 100 is a known enterprise e-commerce application providing a variety of generic platform services supporting marketing material design and dissemination, including: user authentication services, a shopping environment, and checkout services. The marketing resource center 100, by way of example, is an application-specific implementation built upon a known general purpose Magento Enterprise Edition platform.

The marketing resource center 100 supports defining client-enterprise specific store fronts, including unique branding and product catalogs on a client-enterprise basis. The marketing resource center 100 includes an extensive application program interface and customization tools that facilitate integrating the marketing resource center 100 with a variety of add-on functional components including the ones illustratively depicted in FIG. 1. Thus, users access a variety of functions relating to designing and disseminating marketing materials via the marketing resource center 100 and a variety of add-on services provided by integrated components via the marketing resource center 100 to add a variety of functions going beyond merely selecting products/services from a user/client-specific catalog.

The marketing resource center 100 makes it easy to deliver a consistent and branded experience across all media channels by enabling end users to fulfill individual marketing media needs using a common set of core marketing media design descriptions (e.g. templates). Whether end users need to send a localized direct-mail campaign, update in-store displays or any other type of marketing media, the marketing resource center 100 provides centralized marketing materials design and distribution control functionality. Exemplary user interfaces include, after initial user login, an account home page providing users top-level access to: account information, billing and shipping addresses; a list of marketing material orders awaiting approval by the logged on user; and a listing of all previously fulfilled orders (with re-order functionality). Further user interfaces include a catalog of non-customizable inventory items. Yet another interface provides access to customizable products. Selection of a customizable product causes the marketing resource center 100 to invoke operation of a marketing media builder 110 that is described herein below. Additional top-level user interfaces exposed/presented by the marketing resource center 100 include: check out (including order review, payment information, shipping information, etc.).

The marketing media builder 110, based on the known Chili Publish application, provides web-based document customization functionality via the marketing resource center 100 platform. The integrated marketing media builder 110 provides access to the publisher functionality of the marketing media builder 110 application program and facilitates sharing information between the market media builder 110 and the marketing resource center 100. An order and inventory management 150 component maintains records of print stock types used by the system to print out final print media products requested by users via the marketing resource center platform 100. The order and inventory management 150 component supplies actual quantities of remaining print stock, for identified types of print stock, to enable a determination of whether a particular print request can be fulfilled in view of currently available print stock.

The marketing media builder 110, in turn provides an interface to a digital asset management (DAM) provider 120. Integrating the DAM provider 120 with the marketing media builder 110 allows a customer's user base to utilize shared/approved digital assets stored within the DAM. Comparable integrations to other DAM systems are contemplated.

A market list provider 130 service, such as the known Intelligent Direct (MarketMaps) list provider service, is integrated with the marketing resource center 100 to enable, via the marketing resource center platform, open a user interface of the market list provider service 130 to select a target marketing territory for a mailing. After selecting the marketing territory, the corresponding marketing territory information is provided by the market list provider 130 to the marketing resource center 100 with a customer order identification.

The marketing resource center 100 is configured to provide graphical user interfaces enabling users to place orders for customizable marketing material products by placing them into the user's shopping cart. Thereafter, the user may select the designated product for dissemination to a defined geographical and/or logical (e.g. group of email recipients) territory. In the case of physically mailed marketing materials, the marketing resource center 100 presents a mail list acquisition mapping window. The mapping window user interface prompts the user to define a territory for desired mail “In-Home Date” for the designated marketing material from which a mailing list is generated by accessing the data resources of the market list provider 130 service. The market list provider 130 service provides filters for customizing dissemination of marketing materials within a territory based upon a variety of business and individual filters.

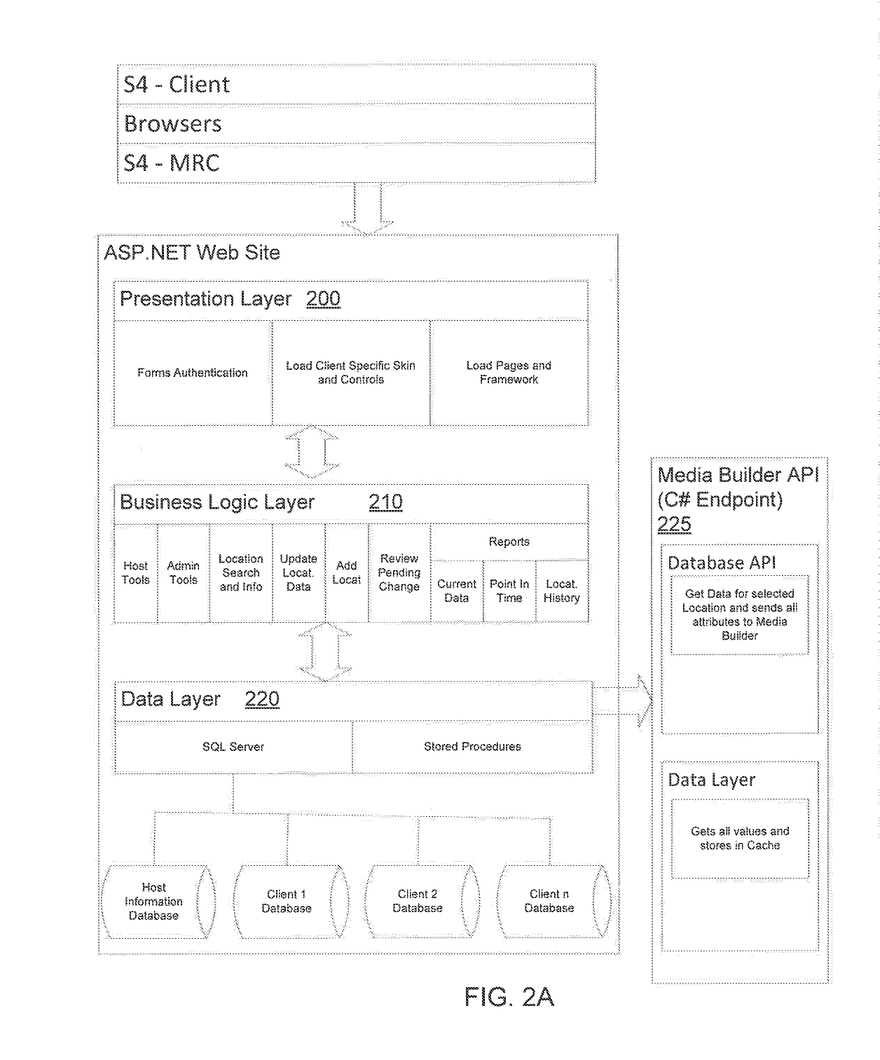

A location manager 140 component is accessed by users of the marketing resource center 100 platform via the marketing media builder 110. The location manager 140 component comprises database functionality for managing a variety of information associated with individual outlets of an enterprise including multiple retail/franchise/distributor locations. Importantly, the location manager 140 supports approval list functionality that initiates (conditionally) an approval operation on any variable data for which approval by specified entities (via an approval list specified for the variable data element). An approval requirement can be specified as “conditional” (according to a predefined condition or conditions), and the approval operation is initiated by the location manager 140 only if the specified conditions are net. The location manager 140 exposes such database capabilities via an interface (see Media Builder API 225 in FIG. 2) built on a custom C# .NET application that supports storing client data in a MICROSOFT SQL server database. An inter-application. interface between the marketing media builder 110 and the location manager 140 enables transfer of location-specific information (e.g., store information and pricing) for incorporation into variable/customizable elements within print media designs generated by users of the marketing media builder 110.

The location manager 140 is a highly configurable, extensible database functionality supporting an extensible set of location-specific information for multi-outlet enterprises including, by way of example, on an outlet location-specific basis: fixtures, location, hours of operation, outlet-specific products/services, prices, contact information, special offers, etc. As indicated in FIG. 1, the outlet-specific information, stored in a database managed under the location manager 140, is accessible via an application interface that populates corresponding documents with outlet-specific information for marketing media designed/defined by users via the marketing media builder 110.

In an exemplary embodiment, the location manager 140 provides the following supported functionality:

1. Deployment of customer branded instances, each with its own array of data fields associated with a location (per site instance). In that regard, users are able to update data fields, labels, screen layout, and validation rules without compilation. Furthermore, a user interface supports user capabilities to search, review, or update location information.

2. Require any changes to location data to be routed for approval prior to updates to the live data including: rules based approvals based on the values in a location specific to any number of attributes; and approvals based on a location (outlet) that is changing outlet-specific information—not the user who is making the change.

3. Audit trail support for all changes to location data, tracking the original value, the user who made the change, the user who approved the change, and the date/time of each.

4. Ability to export location data on-demand, and in standardized format per customer requirements.

5. Administrator interfaces maintain end-user credentials and permissions.

Thus, the marketing resource center 100 is an extensible platform, and as such additional functionality is contemplated in various implementations. Such functions including email notifications, text messaging, etc. The functionality of the location manager 140 is the focus of the present discussion and will be described further herein below.

A print-on-demand order management system 160 coordinates requests, issued by the marketing resource center platform 100, to print out a particular specified marketing media design file (e.g. high-quality Adobe PDF, .gif, etc.) in a specified print stock/format (e.g. poster, banner (large/medium/small), flyer, business card, etc.). By way of example, the marketing resource center platform 100 issues the print request in the form of an XML structure specifying the aforementioned requirements of the order. The art files for the order are supplied by the marketing media builder 110.

The print-on-demand order management system 160 maintains a queue of pending print orders (in XML format) received from the marketing resource center platform 100 and issues print requests to the particular ones of the physical print media printers 170 in accordance with their availability (including the presence of required print stock) to fulfill a particular print request for a specified design file on a particular physical print media. Examples of printers in an exemplary system include (described in the form of: printer name, Min, Sheet Size, Max Sheet Size, Minimum Thickness, Max Thickness, Resolution): Kodak Digimaster E150 8×10 14×18 16 lb. bond 110 lb Cover 600 dpi, Kodak Digimaster EX150 8×10 14×18 16 lb. bond 110 lb Cover 600 dpi, Xerox iGen 7×7 14.33×26 16 lb. bond 24 pt 2400×2400, Kodak NexPress SE3600/3200 7.9×11 14×20.47 16 lb. bond 14 pt 600 dpi, Vutek GS3250 12×12. 126.5-2 600 to 1000 dpi, Vutek QS3200 12×12 126.5-2 540 to 1080 dpi, Duplo DC-645 8.26×8.26 14.56×25.59 30 lb. bond 130 lb.—duplicator.

Turning to FIG. 2A, a schematic depiction of the primary components of the location manager 140 is provided. A presentation layer 200 includes a forms authentication functional component that accepts either MRC SSO or Host Login Credentials. The presentation layer 200 further includes a client-specific skin for loading a client specific/customized interface including customized CSS, Images, and Fonts. The presentation layer 200 furthermore includes client specific controls relating to displaying/editing information relating to previously defined and new locations (outlets) for an enterprise. Additionally, the presentation layer 200 is configured to support a general page layout as well as default stored procedures.

A business logic layer 210 incorporates a variety of supporting, intermediate level functions supporting the overall functionality of the location manager 108. Such functionality includes host tools that facilitate users: viewing data from any store, managing personal login, adding/removing other host accounts, managing approval lists for each client, managing custom field names for each client, providing administration powers to clients, etc. The business logic layer 210 further incorporates a set of administration tools to facilitate: adding/removing administrators for a client, managing rules-based permissions that allow users to view/edit information for certain stores, etc. The business logic layer 210 further incorporates location search and information functionality that uses a custom Stored Procedure for each client to search and display related location information and each client has a custom information display with custom field requirements/validation, and data formatting. The business logic layer 210 incorporates an update location data functionality for submitting a change to the approval process, and marking and locking the field subject to the proposed change until the change is reviewed/approved. The change is submitted to a change history maintained by the location manager 140. The business logic layer 210 incorporates an add location functionality for creating a new location either from scratch or copying an existing location. The information required for specifying a new location (outlet) for an enterprise is customizable for each enterprise (client). The business logic layer 210 incorporates a review pending changes functionality that enables a user to: view all pending changes that have been submitted or that need to be reviewed. Display of pending changes is restricted based upon permissions assigned to a logged on user (role).

The business logic layer 210 incorporates reports generation functionality. The reports functionality supports, in the case of current data: custom rules-based data filters, save/load report filters (Administrators can create public reports that everyone can see), and export data as comma separated values. The reports functionality supports, in the case of point-in-time data: viewing data for any point in time based on full audit trail, custom rules-based data filters, save/load report filters (Administrators can create public reports that everyone can see), and export data as comma separated values. The reports functionality, in the case of location information history: viewing all changes and change reviews for a given location

A data layer 220 of the location manager 140 is implemented, by way of example, in the form of a MICROSOFT SQL server for a plurality of database including: a host information (host login information) as well as a plurality of distinctly maintained client tables (also referred to as client “n” databases). Each client “n” database contains the following information tables/types: client-specific administrator information, client-specific approval history, client-specific approval rules, client-specific defined fields, client-specific stored procedures (potentially overriding a default stored procedures on a client by client basis), and outlet/location information.

A media builder API 225 of the location manager 140 component exposes database capabilities of the location manager 140. The media builder API 225 is a custom C# .NET application that supports storing client data in a MICROSOFT SQL server database. The media builder API 225 provides an inter-application interface between the marketing media builder 110 and the location manager 140 that enables transfer of location-specific information (e.g., store information and pricing) for incorporation into variable/customizable elements within print media marketing designs generated by users via the marketing media builder 110. Such designs are thereafter rendered in the form of print-ready files to the print-on-demand order management system 160 for rendering in a specified physical print media form, by one of the physical print media printers 170, in accordance with a print request submitted by a user via the MRC platform 100 to the print-on-demand order management system.

Turning to FIG. 2B, a listing is provided of an exemplary extensible set of tables utilized by the location manager 140. The tables contain, among other things, location-specific customization information for enterprise-wide print media designs/definitions. In general, the content of the tables contained within the client-specific databases accessed by the data layer 220 enable customers to establish their own set of “friendly names” (labels for fields within the user interface), yet maintain a standard/basic backend structure that lessens the burden of integrating information into a variety of user tools that rely upon the data types enumerated in FIG. 2B. By way of example, the client specific databases use entity-attribute-value (EAV) structures to describe each data instance. This arrangement is intended to provide an efficient data storage format for data elements where only a few fields are generally filled with actual data for each data element/record instance. The EAV approach encourages an open approach to defining the data fields for any given customized data table created by marketing material generating customs. As those skilled in the art will readily appreciate, the database tables identified in FIG. 2B are exemplary and other data item types will be included in accordance with other implementations of the extensible database architectures presented herein.

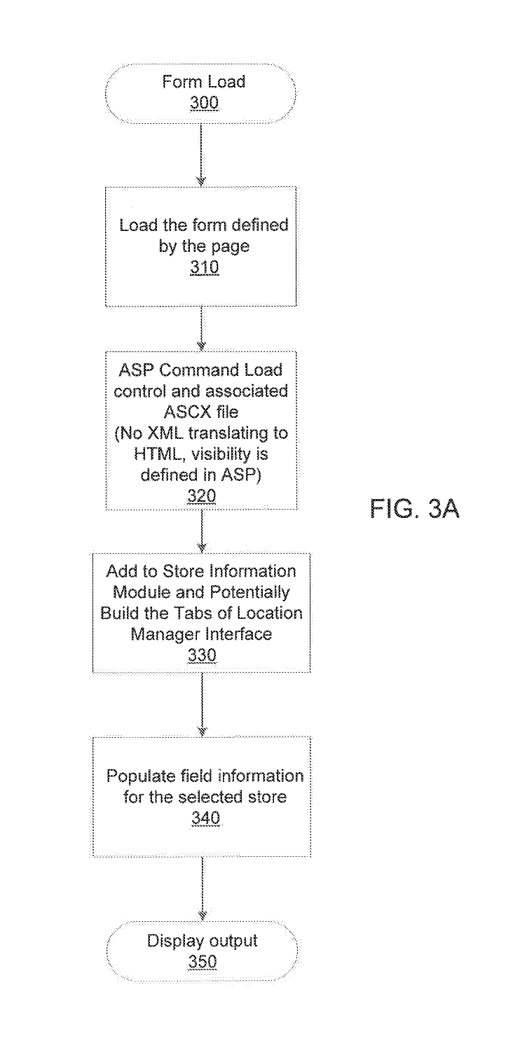

Thus, in summary of the above, the tables identified in FIG. 2B contain information specified and modified by users via the location manager 140. The tables contain information relating to a given entity (e.g. a corporation having multiple retail/franchise outlets), all the data elements relating to assigned locations, and (optional) approval lists and conditions (for requiring the approval of approval list members to make a change to the specified variable data element) for changes to particular ones of the data elements relating to the variable data elements. The variable information is used, during automated generation of print media output in various forms, to pre-populate customizable data elements with location based data that is incorporated into design definitions created/maintained by the marketing media builder 110 when rendering print media output. The table information also drives a change approval process (see FIG. 4 below). Moreover, the table information specifies permissions for limiting variable value changes to particular identified users and/or user classes.

With specific reference to FIG. 2B, an Admin field 230 table contains records for storing an identification/name of an administrator account for a particular instance of the location manager 140.

An Approval History 232 table stores a set of changes and associated approval/rejection decisions by identified users.

An Approval List 234 table stores defined approval types that may be attached to a variable (for which approval must be obtained). Each entry in the Approval List 234 table specifies a name for the approval entry, an identification for a list of required approvers, and a name of a defined condition (or conditions). See Approval List Condition 236 and ApprovalListMembers 238.

An Approval List Condition 236 table contains records, identified by name/unique identification and which additionally contain a field specifying conditions for which approval (by an identified set of approvers) is required. Records in the Approval List Condition 236 table specify a condition (or conditions) under which approvals must be obtained by a list of approvers (specified in an associated “approvers list” element of a record in the Approval list 234 table).

An ApprovalListMembers 238 table stores a set of records, identified by name/unique identification and which additionally contain a field specifying a listing of account names for entities required to approve a change to a variable for which changes require approval (by specifying the name of an entry in the Approval list 234 table.

A Location 239 table contains records corresponding to the Entity part of an EAV database structure. By way of example, each record in the Location 239 table includes: a location identification, a location name and basic location data.

A Field 240 table stores unique field backend names and front end names for a given location instance for a client-specific database. The Field 240 table stores the “Attribute” component of the EAV database content. Similarly, a FieldValue 242 stores the “Value” component of the EAV database content for a given fieldID and locationID.

A FieldValueChange 244 stores a set of records describing a pending/submitted change to a particular type of identified data and identifying (if any) an instance of the ApprovalList records required to provide approval before the proposed change is committed to the database.

A FieldValueChangeHistory 246 table stores a set of records corresponding to a proposed change and whether the proposed change was approved.

A FieldValuePending 248 table stores records indicating data that is being uploaded from a data file.

A FieldValuePendingHistory 250 table stores records containing a describing initial values uploaded from a file.

A Permission 252 table stores records describing users having permission to view information for a particular client location/site. Such permissions may be condition/unconditional based upon the particular configuration of the location.

A SavedReports table 254 contains records storing saved reports. A saved report record is viewable by the public, but may be edited solely by the creator of the saved report.

A Status 256 table stores valid status values for a pending change [Action Required, Approved, Declined, Waiting].

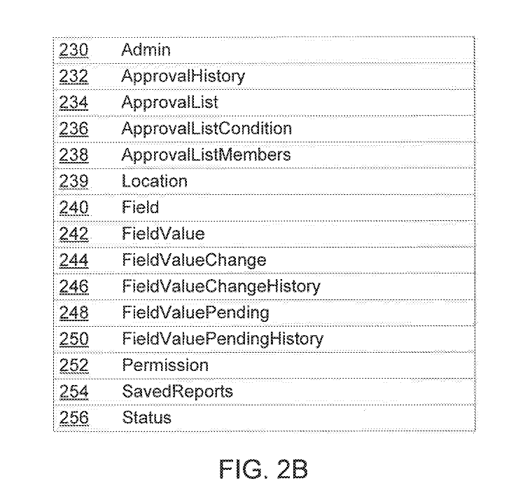

Turning to FIG. 3A, an exemplary set of steps are depicted for a workflow of the location manager 140 for displaying a user interface page containing location-specific information for a particular specified outlet of an enterprise. During 300, a procedure commences for loading/displaying a particular location-manager page based upon a previously defined form. During 310 a generic form for the location manager 140 user interface page is loaded. Thereafter, during 320 an ASCX file is loaded to dynamically build a client-specific customized location manager user interface page/layout. Next, during 330, the user customized client-specific basic user interface page is augmented by definitions of user-selectable tabs based upon a client-specific location manager user interface configuration. Thereafter, during 340 the client-specific page, augmented with tabs is populated with information contained in the EAV structures in the database (see e.g., client 1 database of data layer 220) relating to the location manager page. The resulting page, populated with appropriate information for currently exposed fields of the location manager 140 user interface, is rendered/displayed to the user. An example of such rendered display of the location manager 140 interface is provided in FIG. 3B. In the example a right side of the display for the location manager 140 displays, for a selected location (Big E Foods, Inc), price information (a variable field) for a set of menu items (Topperstix, Pizzas, etc.).

Turning to FIG. 4, an exemplary set of steps are depicted for a workflow of the location manager 140 associated with obtaining approval from designated members on an approval list associated with a changed variable field for an identified outlet/location and then saving the proposed change after obtaining any (optionally specified) required approval(s) from all entities listed in the approval list associated with the changed variable. The procedure commences a 410 with a form save request by a user of the location manager 140. Thereafter, during 415 the changed data value is validated. At 420, if an error was detected during validation, then control passes to 425 wherein the location manager 140 issues/displays an error message next to the field containing the erroneous information (e.g. a number was not entered in a numerical field—e.g. a price field for a specified variable). Otherwise, if the data specified in the change to the variable was valid, then control passes from 420 to 430. During 430, if the changed variable field requires an approval (that may be either conditional or unconditional), then control passes to 435 wherein the location manager 140 stores the proposed change as a pending change record in a pending change table. The pending change records each specify a list (defined by an identified entry in the ApprovalListMembers 238 table) of one or more necessary approvers specified in an approval list associated with the proposed variable change. During 440, the pending proposed variable change record is initially processed by the location manager 140 by issuing email notifications to necessary approvers for the changed variable (and requesting the listed approvers to logon to the location manager 140 and either approve or reject the identified variable value change proposal.

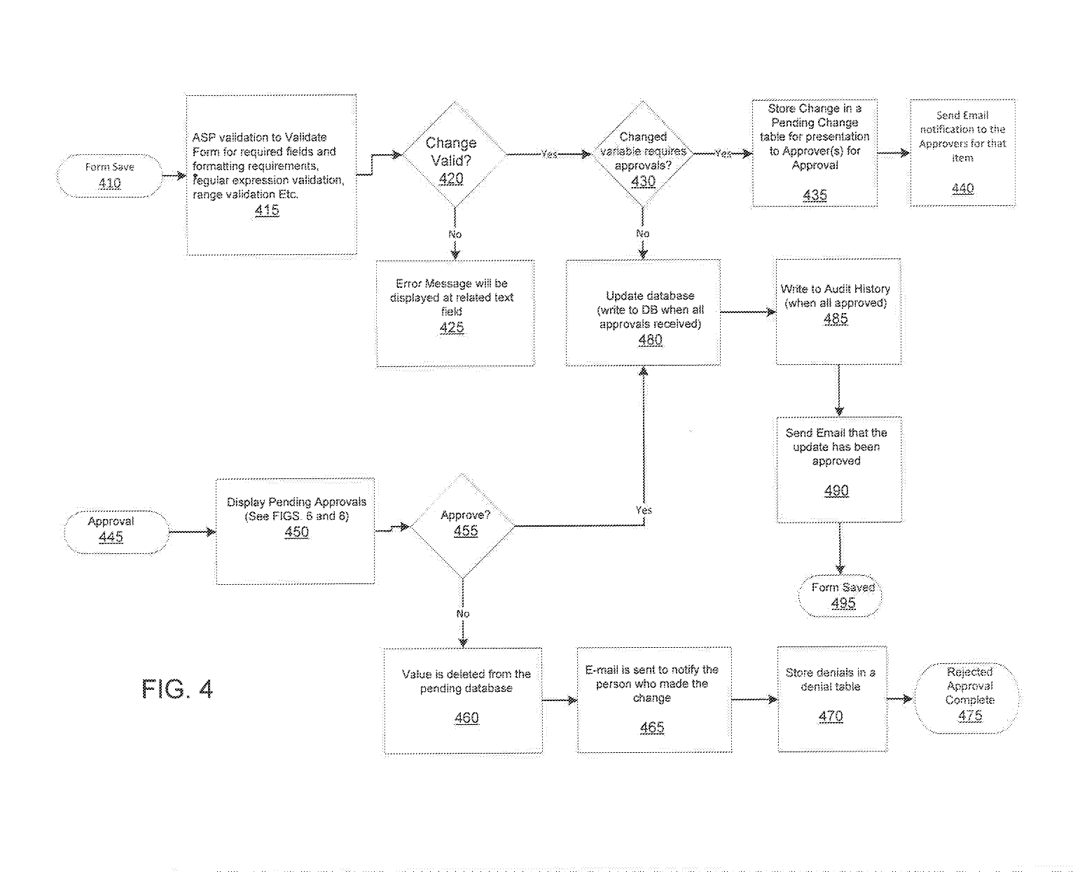

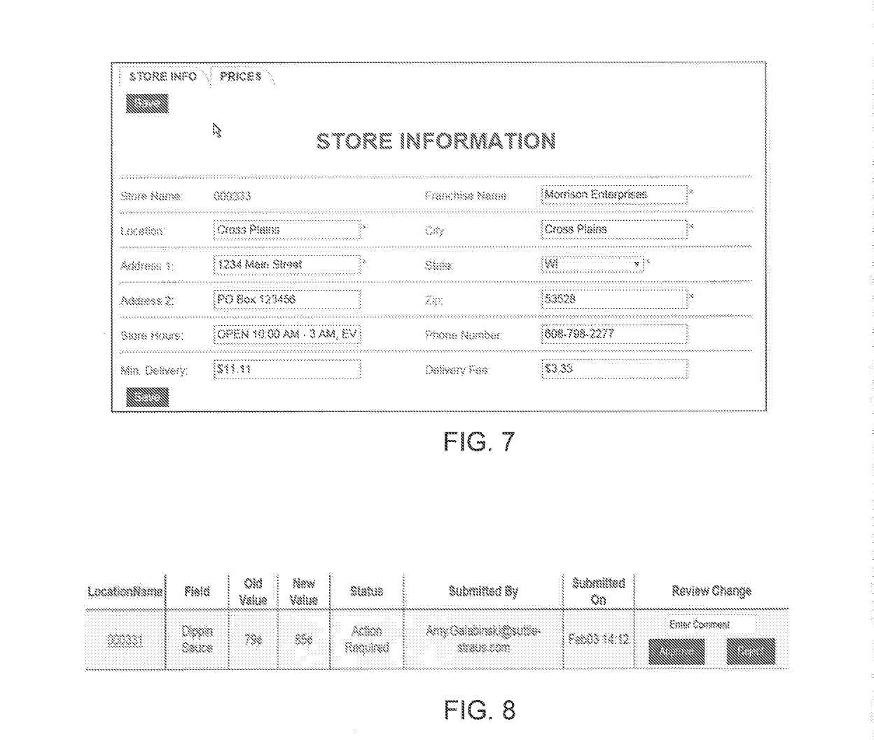

With continued reference to FIG. 4, a procedure for processing a proposed change to a variable that requires at least one approval continues at 445. During 450, an authenticated logged-on user of the location manager 140 accesses a Pending Changes page (see FIG. 6) on the location manager 140 user interface to cause display of a listing of all pending changes requiring approval of the logged-on user. During 455 the designated approver either accepts or rejects the proposed change corresponding to the previously received email notification. An example of a pending change display item is provided in FIG. 8, if at least one required approver rejects a pending proposed change to a data item, then control passes from 455 to 460. During 460 the pending change is deleted from the list of pending change records in the database of the location manager 140. Control then passes to 465 wherein the location manager 140 initiates transmission of an email notification to the logged-on user that saved the proposed variable change at 410 was rejected. At 470, the location manager 140 stores a record of the denial (including the proposed change and the entity that rejected the change) in a proposed change denial table and the process flow for a rejected change is complete at 475.

However, at 455 if the approver (or all designated approvers in a list identifying multiple approvers for a specified change) consents to the change to the variable value, then control passes to 480. If no approvals were needed (during 430), then control passes from 430 to 480 (i.e., the approval process is by-passed).

During 480, the location manager 140 incorporates the pending change to the specified variable value, for a particular location of a multi-location enterprise, into the appropriate variable data table of the client-specific database. During 485, the location manager 485 adds an entry to an audit history table containing a set of records corresponding to (approved) changes to specified variable values for particular locations in the database for the particular client. During 490 the location manager initiates transmission of an email notification to the logged-on user that saved the proposed variable change at 410. The (approved) variable change process flow ends for the saved form at 495.

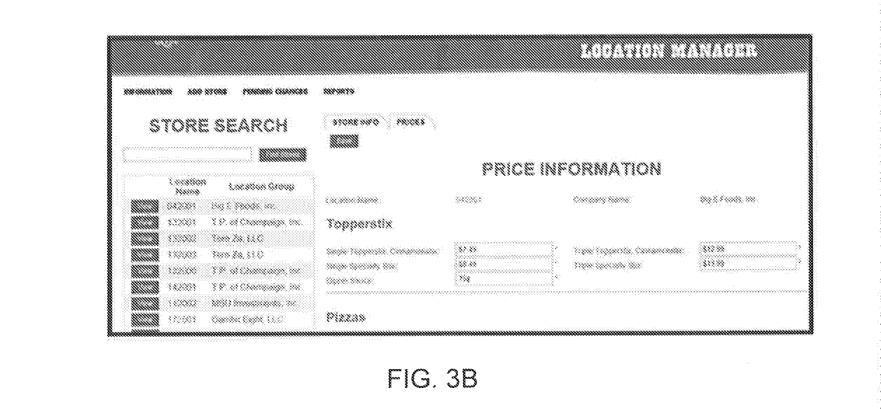

Turning to FIGS. 5-7, the operation of the location manager 140 is summarized/recapped with reference to exemplary user interface elements facilitating the location-specific customization of print media marketing and operations materials for a particular outlet/location of an enterprise comprising multiple outlets/locations. After logging on, an authenticated user is provided access to a set of outlets (stores) corresponding to an enterprise with which the user is affiliated. Turning to FIG. 5, an exemplary store search pane presented by the location manager 140 (via the marketing media center 100 platform) is depicted. A user enters either a store number or a search term to invoke a search on the location manager 140 to retrieve information for one or more responsive locations/outlets for an enterprise. Search terms include: city name, state name, franchise name, etc.

Turning to FIG. 6, an exemplary navigation pane of a home user interface of the location manager 140 is depicted. Clicking on one of the provided fields/tabs invokes operation of the corresponding functional components within the business logic 210 of the location manager 140 described herein above with reference to FIG. 2A.

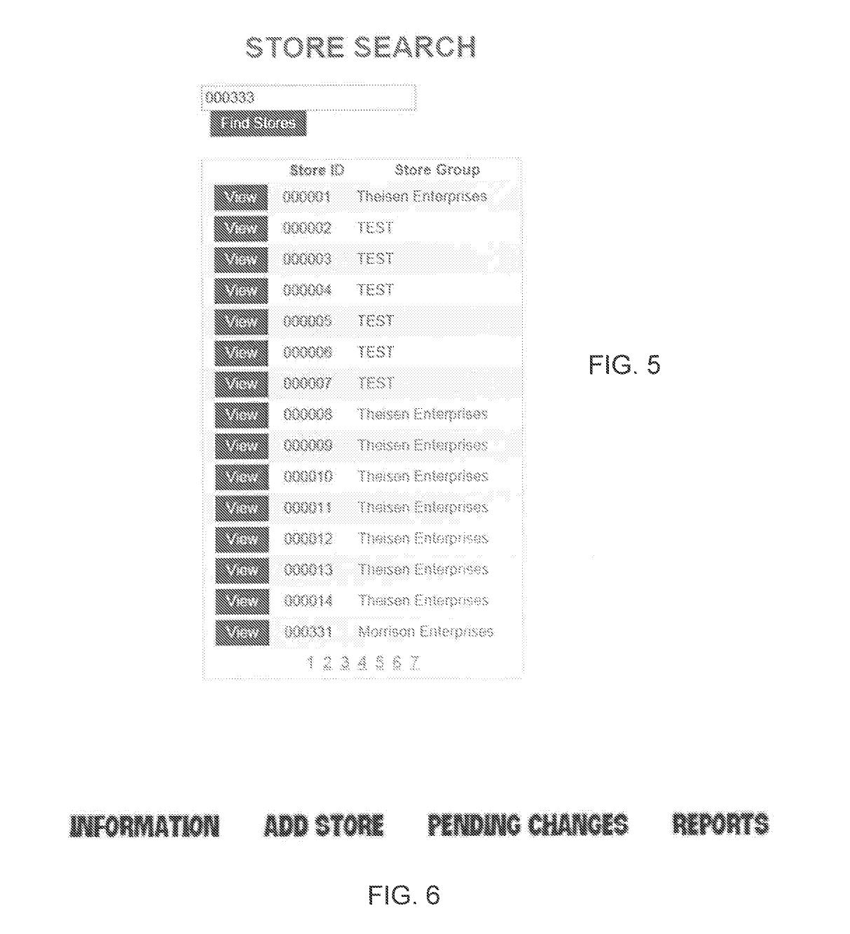

Turning to FIG. 7, an exemplary user interface is provided for enabling a user to view and update outlet-specific information (including “Store Information” and “Prices”) for a selected store (location) of an enterprise. The exemplary user interface presents a number of variable data fields that are associated with a particular store (outlet/location) for a multi-outlet enterprise. A save button initiates the process flow of the location manager 140 discussed herein above with reference to FIG. 4. A variety of data viewing and entry fields are provided based upon a previous definition for outlets of the particular enterprise. The location manager includes built-in interface controls that temporarily lock a data field after a user enters a new value while the proposed change while awaiting a required approval. The field color is modified by the location manager 140 (e.g. black to red) to indicate the particular field/change is temporarily locked while awaiting approval.

Turning to FIG. 8, an exemplary user interface display element is depicted for a pending change that is displayed to a logged on user designated as a required approver for a changed variable value associated with an approval list (which may be conditional). The exemplary pending approval user interface includes a plurality of identification fields: location name, changed variable (field), user that made the change, and date of proposed change. The proposed change entry also specifies: the old/new values for the proposed change, status (e.g. action required). A response field includes: approve/reject buttons and a comment field. The set of fields of the pending change approval request depicted in FIG. 8 are exemplary in nature and other presentation arrangements are contemplated in other examples.

Thus, examples have been described for carrying out location management and integration of location-specific information into marketing and operational print media materials in a system supporting location-specific customization of print media designs in a multi-outlet enterprise environment. Importantly, a single source of templates for an entire enterprise can be modified on a location-specific basis through relatively simple entry of proposed changes to variable fields associated with the print media design definitions. Additionally, the location manager supports an automated approval workflow that ensures required approvals are obtained before committing a proposed/pending change to a database for a multi-outlet enterprise, where such change is incorporated into print media design files for subsequent rendering in the form of physical print media output for the specific location/outlet of the enterprise.

All references, including publications, patent applications, and patents, cited herein are hereby incorporated by reference to the same extent as if each reference was individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for producing location-specific print media for a multi-outlet enterprise, the method comprising:
providing, by a marketing media builder, a set of print media design templates for the multi-outlet enterprise, wherein the templates include variable data fields;
maintaining sets of location-specific information for populating the variable data fields of the set of print media design templates; and
performing, by a print-on-demand order management system, the steps of:
receiving a request for generating a print job specifying a print quality image file from the marketing media builder,
receiving a request for a particular output form for printing a physical rendering of the print quality image file, and
issuing instructions and data to a physical print media printer to render physical print media output according to e print quality image file and the particular output form; and
rendering, by the physical print media printer, print media output in physically tangible form,
wherein the print quality image file is generated by the marketing media builder by populating the variable form fields with variable data acquired from the location manager for a particular location.

2. The method of claim 1 wherein the sets of location-specific information include a user-modifiable variable data element that specifies a required approval prior to storing in the database, and wherein the method further comprises performing, by the location manager, the further steps of:
receiving a proposed request including a proposed change to a value of the user-modifiable variable data element;
coordinating, via electronic message transactions, obtaining the required approval, and
entering, after obtaining the required approval, the proposed change to the value of the user-modifiable variable data element.

3. A system for producing location-specific print media for a multi-outlet enterprise, the system comprising:
a marketing media builder configured to provide a set of print media design templates for the multi-outlet enterprise, wherein the templates include variable data fields;
a location manager comprising a database configured to maintain sets of location-specific information for populating the variable data fields of the set of print media design templates;
a physical print media printer configured to render print media output in physically tangible form; and
a print-on-demand order management system comprising a processor and a non-transitory computer-readable medium including computer executable instructions that, when executed by the processor, facilitate performing on the print-on-demand order management system, the steps of:
receiving a request for generating a print job specifying a print quality image file from the marketing media builder,
receiving a request for a particular output form for printing a physical rendering of the print quality image file, and
issuing instructions and data to the physical print media printer to render physical print media output according to the print quality image file and the particular output form,
wherein the print quality image file is generated by the marketing media builder by populating the variable form fields with variable data acquired from the location manager for a particular location.

4. The system of claim 3 wherein the sets of location-specific information include a user-modifiable variable data element that specifies a required approval prior to storing in the database, and wherein the location manager is further configured to perform the steps of:
receiving a proposed request including a proposed change to a value of the user-modifiable variable data element;
coordinating, via electronic message transactions, obtaining the required approval, and
entering, after obtaining the required approval, the proposed change to the value of the user-modifiable variable data element.

5. A non-transitory computer-readable medium including computer-executable instructions for producing location-specific print media for a multi-outlet enterprise, the computer-executable instructions configuring a hardware processor to carry out a method comprising:
providing a set of print media design templates for the multi-outlet enterprise, wherein the templates include variable data fields;
maintaining sets of location-specific information for populating the variable data fields of the set of print media design templates; and
performing, by a print-on-demand order management server, the steps of:
receiving a request for generating a print job specifying a print quality image file from the marketing media builder,
receiving a request for a particular output form for printing a physical rendering of the print quality image file, and
issuing instructions and data to a physical print media printer to render physical print media output according to e print quality image file and the particular output form,
wherein the print quality image file is generated by the marketing media builder by populating the variable form fields with variable data acquired from the location manager for a particular location.

6. The non-transitory computer-readable medium of claim 5 wherein
wherein the sets of location-specific information include a user-modifiable variable data element that specifies a required approval prior to storing in the database, and wherein the method further comprises:
receiving a proposed request including a proposed change to a value of the user-modifiable variable data element;
coordinating, via electronic message transactions, obtaining the required approval, and
entering, after obtaining the required approval, the proposed change to the value of the user-modifiable variable data element.
